(19) United States
(12) Patent Application Publication
(10) Pub. No.: US 2013/0154886 A1
(43) Pub. Date: Jun. 20, 2013

(54) LOOSELY-COUPLED RADIO ANTENNA APPARATUS AND METHODS

(71) Applicant: Anne Isohätälä, Kello (FI)

(72) Inventor: Anne Isohätälä, Kello (FI)

(21) Appl. No.: 13/331,802

(22) Filed: Dec. 20, 2011

(51) Int. Cl. H01Q 1/24

(52) U.S. Cl. 343/702

(57) ABSTRACT

A multiband internal antenna apparatus and methods of tuning and utilizing the same. In one embodiment, the antenna configuration is used within a handheld mobile device (e.g., cellular telephone or smartphone). The device enclosure is fabricated from a conductive material and has two parts: the main portion, housing the device electronics and ground plane, and the antenna cap, which substantially envelops a directly fed radiator structure of the antenna. Electromagnetic coupling of the cap portion to the device feed effects formation of a parasitic antenna radiator in a lower frequency band. The cap portion is separated from the main portion by a narrow gap, extending along circumference of the device, and is grounded at a location selected to cause desired resonance and to widen antenna bandwidth. In one implementation, a second parasitic radiator is disposed proximate the directly feed radiator to further expand antenna frequency bands of operation.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to antenna apparatus for use in electronic devices such as wireless or portable radio devices, and more particularly in one exemplary aspect to an internal multiband antenna for use with conductive enclosures, and methods of tuning and utilizing the same.

### DESCRIPTION OF RELATED TECHNOLOGY

Internal antennas are an element found in most modern radio devices, such as mobile computers, mobile phones, Blackberry® devices, smartphones, personal digital assistants (PDAs), or other personal communication devices (PCDs). Typically, these antennas comprise a planar radiating plane and a ground plane parallel thereto, which are connected to each other by a short-circuit conductor in order to achieve the matching of the antenna. The structure is configured so that it functions as a resonator at the desired operating frequency. It is also a common requirement that the antenna operate in more than one frequency band (such as dual-band, tri-band, or quad-band mobile phones), in which case two or more resonators are used.

Recent advances in the development of affordable and power-efficient display technologies for mobile applications (such as liquid crystal displays (LCD), light-emitting diodes (LED) displays, organic light emitting diodes (OLED), thin film transistors (TFT), etc.) have resulted in a proliferation of mobile devices featuring large displays, with screen sizes of for instance 89-100 mm (3.5-4 in.) in mobile phones, and on the order of 180 mm (7 in.) in some tablet computers. These trends, combined with user demands for robust and ascetically attractive device enclosures, increase the use of metal chassis and all-metal device enclosures. These metal enclosures and components often act as electromagnetic shields and reduce antenna efficiency and bandwidth, which adversely affects operation of internal radio frequency antennas, particularly at low frequencies.

Furthermore, modern third and fourth generation high-speed wireless networks, such as Wideband Code Division Multiple Access (W-CDMA), Universal Mobile Telecommunications System (UMTS), High-Speed Packet Access (HSPA), and 3GPP Long Term Evolution (LTE/LTE-A), require radio devices that operate in multiple frequency bands over a wide range of frequencies (e.g., 700 MHz to 2700 MHz).

Various methods are presently employed to attempt to improve antenna operation with metallic or metalized enclosures. Capacitively fed monopole antennas achieve wide bandwidth using switches. However, the use of electrical switching requires specialized matching, and often results in high electrical losses. Some existing solutions utilize various cut-outs and partial metalized enclosures in order to minimize antenna radiation losses and improve performance. In addition, active switching and tuning circuits require additional components which increase complexity, cost and size of the portable radio device. As the number of supported frequency bands increases (e.g., to support LTE/LTE-A), active switching antennas become more difficult to implement in metalized enclosures while maintaining antenna performance (and obeying aesthetic considerations such as shape and size).

Accordingly, there is a salient need for a wireless multiband antenna solution for e.g., a portable radio device, with a small form factor and which is suitable for use with metal/metalized device enclosures. Ideally, such solution would also offer a lower cost and complexity, as well as supporting multiple frequency bands while maintain good radiation efficiency.

### SUMMARY OF THE INVENTION

The present invention satisfies the foregoing needs by providing, inter alia, a space-efficient multiband antenna apparatus, and methods of tuning and use thereof.

In a first aspect of the invention, an antenna apparatus is disclosed. In one embodiment, the apparatus comprises: a loosely coupled main antenna radiator having a single feed point connection; and a diversity antenna element. The antenna apparatus is configured to utilize at least a portion of a metallic enclosure of a host device as a parasitic resonator; and is capable of at least receiving signals in a plurality of frequency bands within both lower and upper operating frequency ranges.

In one variant, the antenna apparatus does not include any tuning circuitry or switches.

In another variant, the host device includes a mobile cellular telephone, and the frequency bands are at least in part compliant with those specified in the Long Term Evolution (LTE) wireless standard.

In yet another variant, the antenna apparatus forms a first parasitic resonator using the main antenna radiator, and a second parasitic resonator using the diversity antenna element.

In a second aspect of the invention, a radio frequency communications device is disclosed. In one embodiment, the device includes: an electronics assembly comprising a ground plane and a feed port; at least partially electrically conductive external enclosure comprising a main portion enclosing the electronics assembly, and a first end cap enclosing a first antenna radiator having a feed structure connected to the feed port. The first antenna radiator is configured to operate in at least a first frequency band; and the first end cap is connected to the ground plane at least at a first location, thereby forming a first parasitic radiator in a second frequency band.

In one variant, the first antenna radiator and the first parasitic radiator form a first multiband antenna apparatus; and the first parasitic radiator is configured to widen an operating bandwidth of the first multiband antenna apparatus.

In another variant, the grounding of the first end cap is configured to increase radiation efficiency of the multiband antenna apparatus.

In another variant, the first end cap is disposed proximate a first end of the device, and the external enclosure is fabricated from metal (e.g., all metal, or a non-conductive carrier and a conductive layer disposed thereon).

In yet another variant, the main portion is connected to ground in at least one location; and the connection of the first end cap to the ground plane is effected via the main portion.

In a third aspect of the invention, a multiband antenna apparatus for use in a radio communications device is disclosed. In one embodiment, the device has at least partially conductive external enclosure, and the antenna apparatus comprising a directly fed radiator structure having a feed portion configured to be connected to feed port of the radio communications device. The directly fed radiator structure is operable in at least a first frequency band and configured to be electromagnetically coupled to an end cap portion of the external enclosure; the end cap is electrically connected to a ground plane of the radio device via a ground structure; the grounding of the end cap is configured to widen operating bandwidth of the multiband antenna apparatus; and the enclosing of the directly fed radiator structure by the end cap and the grounding of the end cap cooperate to form a parasitically-fed radiator of the antenna apparatus in a second frequency band.

In one variant, the grounding of the end cap is configured to increase radiation efficiency of the multiband antenna apparatus, and the second band is lower than the first band.

In another variant, the end cap is configured to substantially enclose the directly fed radiator structure on at least on five sides.

In yet another variant, the directly fed radiator structure includes a first portion configured substantially parallel to the ground plane, and a second portion configured substantially perpendicular to the ground plane. The antenna includes a parasitic radiator disposed proximate to the feed portion and configured to form an electromagnetically coupled resonance in at least a third frequency band.

In a fourth aspect of the invention, a method of expanding operational bandwidth of a multiband antenna useful in a radio device is disclosed. In one embodiment, the device has an at least partially conductive external enclosure, and the method includes: energizing a first radiator structure in at least a first frequency band by effecting an electric connection between the first radiator and a feed port of the radio device; and energizing a second antenna radiator structure in at least a second frequency band by: (i) electromagnetically coupling the second radiator structure to the feed port; and (ii) effecting an electric ground connection between the second radiator structure and a ground plane of the radio device.

In one variant, the second radiator structure includes an end cap portion of the external enclosure; and the end cap portion is connected to the ground plane at least at a first location that is selected to widen operating bandwidth of the multiband antenna.

In a fifth aspect of the invention, an antenna radiator structure for use in a wireless device is disclosed. In one embodiment, the structure includes: a directly fed radiating element in electrical communication with a feed structure; and a second radiating element with a slot formed therein. The directly fed radiating element and the second radiating element are configured to be disposed in a substantially perpendicular orientation when installed within a host device enclosure.

In one variant, the structure further includes a parasitic element adapted for communication with a ground of the host device, the parasitic element configured for placement proximate the feed structure and to resonate at a frequency other than that of the directly fed radiating element or the second radiating element.

In another variant, the slot is configured to create a first resonant frequency of a high frequency band associated with the structure. The directly fed radiating element includes an end portion used to tune a first harmonic of a low band resonance into the high frequency band, thus forming a second high frequency resonance.

In another aspect of the invention, a method of operating a multiband antenna apparatus is disclosed. In one embodiment, the antenna apparatus is for use in a portable radio device, and the method includes causing a resonance in a parasitic resonator of the antenna to create a frequency band outside the main antenna band(s).

In yet another aspect of the invention, a method of tuning a multiband antenna apparatus is disclosed.

Further features of the present invention, its nature and various advantages will be more apparent from the accompanying drawings and the following detailed description.

### BRIEF DESCRIPTION OF THE DRAWINGS

The features, objectives, and advantages of the invention will become more apparent from the detailed description set forth below when taken in conjunction with the drawings, wherein:

FIG. 1 provides front and rear elevation views of a mobile device comprising a conductive enclosure and internal antenna apparatus configured according to one embodiment of the invention.

FIG. 2 is an end perspective view of one embodiment of main antenna radiator useful with the conductive device enclosure of the embodiment shown in FIG. 1.

FIG. 3 is a top plan view of the main antenna element (showed in planar disposition before folding).

FIG. 4 is a plot of measured input return loss obtained with an exemplary five-band main antenna apparatus configured in accordance with the embodiment of FIGS. 1-3 and coupled to the enclosure conductive cover, for the following configurations: (i) measured in free space; (ii) measured according to CTIA v3.1 beside head, right cheek; and (iii) measured according to CTIA v3.1 beside head with hand, right cheek.

FIG. 5 is a plot of total efficiency obtained with an exemplary five-band main antenna apparatus configured in accordance with the embodiment of FIGS. 1-3 and coupled to the conductive cover, for the following configurations: (i) measured in free space; (ii) measured according to CTIA v3.1 beside head, right cheek; and (iii) measured according to CTIA v3.1 beside head with hand, right cheek.

FIG. 6 is a plot of envelope correlation coefficient (ECC) between the main and diversity antennas obtained with an exemplary multi-band antenna apparatus configured in accordance with the embodiment of FIG. 1, for the following configurations: (i) measured in free space; (ii) measured according to CTIA v3.1 beside head, right cheek, and (iii) measured according to CTIA v3.1 beside head with hand, right cheek.

All Figures disclosed herein are © Copyright 2011 Pulse Finland Oy. All rights reserved.

### DETAILED DESCRIPTION OF THE PREFERRED EMBODIMENT

Reference is now made to the drawings wherein like numerals refer to like parts throughout.

As used herein, the terms “antenna,” “antenna system,” “antenna assembly”, and “multi-band antenna” refer without limitation to any apparatus or system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “portable device”, “mobile computing device”, “client device”, “portable computing device”, and “end user device” include, but are not limited to, personal computers (PCs) and minicomputers, whether desktop, laptop, or otherwise, set-top boxes, personal digital assistants (PDAs), handheld computers, personal communicators, tablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna or portion thereof.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), TD-LTE, analog cellular, CDPD, satellite systems such as GPS, millimeter wave or microwave systems, optical, acoustic, and infrared (i.e., IrDA).

### Overview

The present invention provides, in one salient aspect, a multiband antenna apparatus for use in a mobile radio device having an electrically conductive enclosure. The exemplary embodiments of the antenna apparatus described herein advantageously offer reduced complexity and cost, and improved antenna performance, as compared to prior art solutions. In one implementation, the antenna apparatus comprises a main antenna radiator disposed on one end of the device enclosure, and diversity or a multiple-input multiple-output (MIMO) antenna radiator disposed on opposite end. The mobile radio device comprises a metallic enclosure (e.g., a fully metallic, or an insulated metal carrier) which comprises a main portion and two antenna cover portions (caps) that substantially completely enclose the main and the diversity antenna radiating elements, respectively. Both antenna caps are separated from the main enclosure portion by a narrow gap extending along the circumference of the device. In order to reduce losses due to handling during operation, the surface of metal cover may be comprise a non-conductive layer, e.g., plastic film.

The main antenna radiator comprises a loosely-coupled antenna, which is also referred to as the ring antenna. The feed of the main antenna is connected to the device RF feed structure, thus requiring only a single connection between the main antenna radiator and the device electronics. The main portion of the device conductive enclosure is connected to ground at one or more predetermined locations. In one implementation, the main portion is grounded at four points (two per side, one on each end) disposed substantially along a longitudinal axis of the enclosure. In another implementation, additional grounding points are used, such as, for example, proximate the device sides.

The cap portion that covers the main antenna feed is loosely coupled to the feed element, thus forming a parasitic antenna resonator. In some implementations, the antenna cap is connected to device ground plane in order to adjust antenna resonant frequency in low frequency band, to widen the antenna bandwidth, and to enhance radiation efficiency of the antenna.

Advantageously, the coupling of the feeding element to the grounded (short-circuited) metallized cover portion surrounding the feeding element and being a part of metallized phone enclosure enables the cover portion to operate as a parasitic antenna resonator at low frequencies. Furthermore, coupling of the main and diversity antenna to the device electronics described herein is much simplified, as only a single feed connection is required (albeit not limited to a single feed).

In one particular implementation, a high frequency band parasitic resonator structure is disposed proximate to the directly fed radiator structure of the feeding element radiator in order to widen antenna operating bandwidth. The parasitic structure is located along one side of the device enclosure and is galvanically connected to ground.

Methods of tuning and operating the antenna apparatus are also disclosed.

### DETAILED DESCRIPTION OF EXEMPLARY EMBODIMENTS

Detailed descriptions of the various embodiments and variants of the apparatus and methods of the invention are now provided. While primarily discussed in the context of mobile devices, the apparatus and methodologies discussed herein are not so limited. In fact, many of the apparatus and methodologies described herein are useful in any number of complex antennas, whether associated with mobile or fixed devices (e.g., base stations or femtocells), cellular or otherwise.

### Exemplary Antenna Apparatus

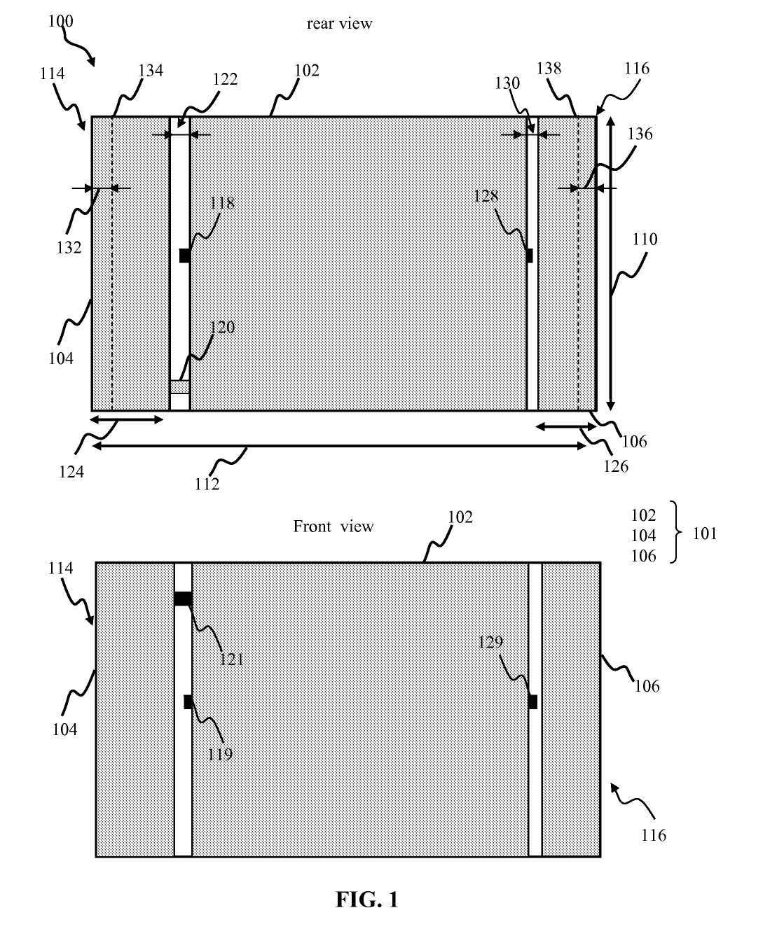

Referring now to FIGS. 1 through 3, various embodiments of the radio antenna apparatus of the invention are described in detail. One exemplary configuration of the antenna apparatus for use in a mobile radio device is presented in FIG. 1. The host mobile device 100 comprises an external enclosure 101, having width 110 and length 112, and fabricated from metal, such as aluminum, steel, copper, or other suitable alloys. It is appreciated that while this device is shown having a generally rectangular form, the invention may be practiced with devices that possess other form factors; e.g., square, oval, etc.

A printed circuit board (PCB), comprising radio frequency electronics and a ground plane, is disposed within the device 100. In one variant, the enclosure 101 is fabricated using a plastic carrier structure with a metalized conductive layer (e.g., copper alloy) disposed on its external surface.

As shown in FIG. 1, the enclosure 101 comprises a main portion 102 and two end cap portions; i.e., the main antenna end cap 104 and the diversity antenna end cap 106. In one variant, only a single end cap (e.g., 104) is used, and the main portion includes both portions 102, 106. In the embodiment of FIG. 1, the main end cap is disposed proximate a bottom end of the radio device 100, while the diversity end cap covers the top end of the device. The length 124, 126 of each of the main antenna end cap 104 and the diversity antenna end cap 106 is about 13 mm (0.5 in), although other values may be used with equal success. In one variant, the end caps 104, 106 are disposed proximate to left and right sides of the device.

In one approach, the end caps are fabricated from solid metal, and are spaced from the feeding element by a predetermined distance (typically on the order of 1 mm). In another approach, the end caps comprise a metal covered plastic, fabricated by any suitable manufacturing method (such as, for example laser direct structuring, (LDS)). In this variant, the plastic thickness provides sufficient gap between the metal end cap portion and the feed structure; hence, additional spacing is not required.

The first end cap 104 is separated from the main portion 102 by a gap 122, and the other end cap 106 is separated from the main portion 102 by a gap 130. In the embodiment shown in FIG. 1, the exemplary enclosure 101 is 57 mm (2.3 in) wide, 120 mm (4.7 in) long and 10 mm (0.4 in) thick. The gaps 122, 130 are 3 mm (0.118 in) and 1.5 mm (0.069 in) wide, respectively. The gaps 122, enable tuning of the antenna resonant frequency, bandwidth, and the radiation efficiency. Typically, a narrower gap corresponds to a lower resonant frequency, lower efficiency, and narrower bandwidth. It will be appreciated by those skilled in the arts given the present disclosure that the above dimensions correspond to one particular antenna/device embodiment, and are configured based on a specific implementation and are hence merely illustrative of the broader principles of the invention.

The main portion 102 of the enclosure is connected to the ground plane device (not shown) at multiple locations 118, 128, 119, 129 in order to achieve good coupling, and to minimize electrostatic discharge (ESD) problems. In the embodiment of FIG. 1, the ground locations are disposed along a longitudinal axis of the enclosure, with two (2) of the four (4) locations (the location 118 near the bottom end and the location 128 near the top end) grounding the top surface of the enclosure, and with two of the locations (the area 119 near the bottom end and the area 129 near the top end) 118, 128 grounding the bottom surface of the enclosure. The ground connections 118, 119, 128, 129 are effected via any method suitable for creating a high quality ground, including but not limited to a solder or brazed connection, a ground screw, a clip, a spring-loaded pin, etc.

In one variant, additional ground contacts (not shown) are disposed along the left and right sides of the main portion in order to minimize potential occurrence of unwanted resonances, thereby improving the robustness of antenna operation.

The radio device 100 comprises a main antenna apparatus 114 and a diversity antenna apparatus 116, disposed proximate the bottom and top ends of the device, respectively, as shown in FIG. 1. In another embodiment, the locations of the main antenna and the diversity antenna are reversed from the foregoing. The first end cap 104 encloses the main antenna feeding element, thus forming a parasitic radiator portion of the main antenna 104. Similarly, the second end cap 106 covers the diversity antenna feeding element, thus forming a parasitic radiator portion of the diversity antenna 106.

The main antenna 114, in the embodiment shown in FIG. 1, is configured to operate in multiple (in this case five) frequency bands; i.e., 850, 900, 1800, 1900 and 2100 MHz. The diversity antenna 114, in the embodiment shown in FIG. 1, is similarly configured to operate in the above five frequency bands, although it is not necessary that the number of bands of the two antennas be the same or related. The ground clearances for both antennas 114, 116 are about 12 mm (0.5 in) in the illustrated embodiment.

The main antenna end cup 104 is connected to PCB ground at a grounding structure 121. As shown in the embodiment of FIG. 1, the grounding structure 121 connects the end cap 104 to the main enclosure portion 102 in order to achieve the end cap 104 grounding. In another implementation, the grounding structure 121 comprises a direct connection to the device PCB ground by way of a wire, trace, or a flex or other type of cable. The location of the grounding structure 121 is selected such that to form a resonance at a desired frequency within the conductive portion of the end cap 104.

In some embodiments, the diversity antenna 116 comprises a capacitively fed monopole antenna, such as for example that described in PCT Patent Publication No. 2011/101534, entitled “ANTENNA PROVIDED WITH COVER RADIATOR”, incorporated herein by reference in its entirety.

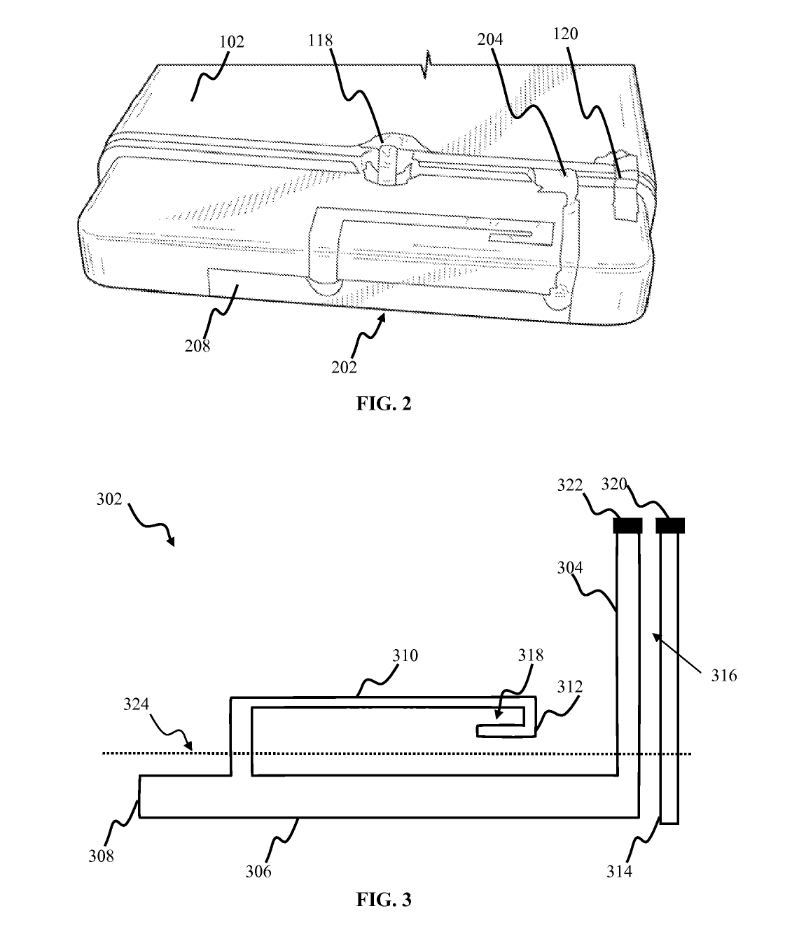

Referring now to FIG. 2, one embodiment of a feeding element of the antenna of the invention is shown and described in detail. The antenna feeding structure 202 comprises a directly fed element 208 coupled to the device feed port via the feed structure 204. The direct-feed radiator of the embodiment shown in FIG. 2 is disposed parallel to the end side of the main end cap 104 (not shown), and is spaced from it (by an approximately 1 mm gap in this embodiment) in order to provide sufficient electromagnetic coupling. The conductive end cap 104 is electromagnetically coupled to the device feed via the feeding element 208, thereby creating a parasitic resonator in the low frequency range. In the antenna embodiment of FIGS. 1-2, the feeding structure 202 is configured to resonate at frequencies of 900 MHz, 1800 MHz, 1900 MHz, and 2100 MHz, while the end-cap 104 resonates at about 850 MHz.

In one embodiment, the antenna feeding structure 202 comprises a parasitically coupled feed structure that is electrically connected to the main enclosure portion (or PCB ground) via the grounding structure 120, and which forms a parasitically coupled resonance in the high frequency range, thereby increasing the antenna operating bandwidth.

As used herein, the terms “low frequency” and “high frequency” are used to describe a first frequency range which is lower in frequency than the second range, respectively, and which may contain multiple bands. In the exemplary embodiment, the lower range extends from about 800 MHz to about 950 MHz, while the high or upper frequency range extends from about 1700 MHz to about 2700 MHz. However, the invention described herein is not so limited, and other frequency band configurations (including those which overlap with one another) may be used consistent with the invention, based on the specific application The main antenna apparatus 114, including the feeding element 202 and the main end cap radiator 104, comprises a loosely-coupled antenna structure, which is also referred to as a “ring antenna”. The ring antenna is formed, in one embodiment, by electromagnetically coupling the directly fed radiator 208 to the short-circuited conductive end cap enveloping the radiator surrounding the feeding element, and by virtue of being a part of metallized phone enclosure. In one implementation, only a single electrical connection between the device PCB and the antenna radiator is advantageously required (i.e., the feed connection 204), thereby simplifying manufacturing and construction.

FIG. 3 illustrates one exemplary embodiment of the main antenna radiator (e.g., the radiator 202 in FIG. 2) for use with the loosely-coupled antenna apparatus (e.g., the antenna 114 of FIG. 1), shown in a planar disposition; i.e., before folding for installation in the mobile device 100. The radiator structure 302 comprises the directly fed radiator portion 306, 308 (that is connected to the device feed port 322 via the feed structure 304), and a C-element 310, 312 which forms a slot 318 therein. When installed, the antenna radiator 302 is folded along the dotted line 324 so that the radiator structure 306, 308 and the C-element 310, 312 are disposed perpendicular to one another within the device enclosure. In one implementation, the radiator 302 further comprises a parasitic element 314 that is connected to the device ground via the grounding structure 320. The total length of all radiator elements (304, 306, 308, 310, 312) determines a first resonant frequency FL1 within the low frequency range. The slot 318 formed by the design of the feeding element creates the first resonant frequency of the high band (FH1). The end portion of the radiator structure 308 is used to tune a first harmonic of the low band resonance into the high band, thus forming a second high frequency resonance (FH2).

The parasitic element 314 is disposed proximate the feed structure 304 so as to ensure sufficient electromagnetic coupling to the antenna feed port via the slot 316 formed between the elements 304, 314, thus forming a third high frequency resonance (FH3).

As will be understood by those skilled in the arts when given this disclosure, the radiator structure of FIG. 3 presents one exemplary embodiment, and many other antenna radiator configurations may be used. By way of example, the length of the parasitic radiator 314 can be reduced, so that the radiator 314 is disposed completely co-planar with the antenna radiator elements 310, 312.

### Performance

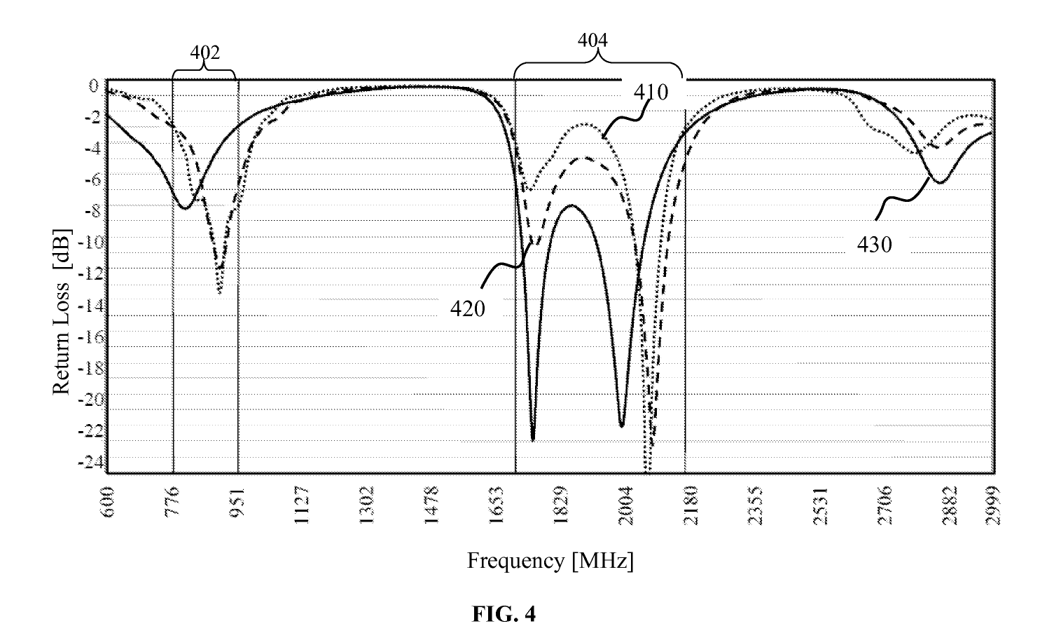

FIGS. 4 through 6 present performance results obtained during simulation and testing by the Assignee hereof of an exemplary antenna apparatus constructed according to one embodiment of the invention.

FIG. 4 is a plot of return loss S11 (in dB) as a function of frequency, measured with the five-band multiband antenna constructed similarly to the embodiment depicted in FIGS. 1-3, for the following measurement configurations: (i) free space; (ii) measured according to CTIA 3.1 specification beside head, right cheek; and (iii) measured according to CTIA 3.1 specification beside head, with hand grasping the device by the right cheek.

The five antenna frequency bands in this sample include two 850 MHz and 900 MHz low frequency bands, and three upper frequency bands (i.e., 1,710-1,880 MHz, 1,850-1,990 MHz, and 1,920-2,170 MHz). The solid lines designated with the designators 402 in FIG. 4 mark the boundaries of the exemplary lower frequency band, while the lines designated with the designator 404 mark the boundaries of the higher frequency band.

The curves marked with designators 410, 420, 430 in FIG. 4 correspond to the measurements taken (i) in free space; (ii) according to CTIA 3.1 specification beside head, right cheek; and (iii) according to CTIA 3.1 specification beside head, with hand grasping the device by the right cheek, respectively.

Data presented in FIG. 4 demonstrate that the exemplary antenna comprising a main radiator and a loosely coupled conductive end cap radiator advantageously reduces free space loss, particularly in the lower frequency range (here, 770 MHz to 950 MHz). Furthermore, the high frequency bandwidth of the loosely coupled main antenna (about 460 MHz), configured according to the invention, advantageously exceeds the high frequency bandwidth compared to the metal cover antenna solutions of the prior art.

Exemplary antenna isolation data (not shown) obtained by the Assignee hereof reveals about 9 dB, 17 dB of antenna isolation in the lower and upper frequency ranges, between the main and the diversity antennas. Such increased isolation advantageously reduces potential detrimental effects due to e.g., Electrostatic Discharge (ESD) during device operation.

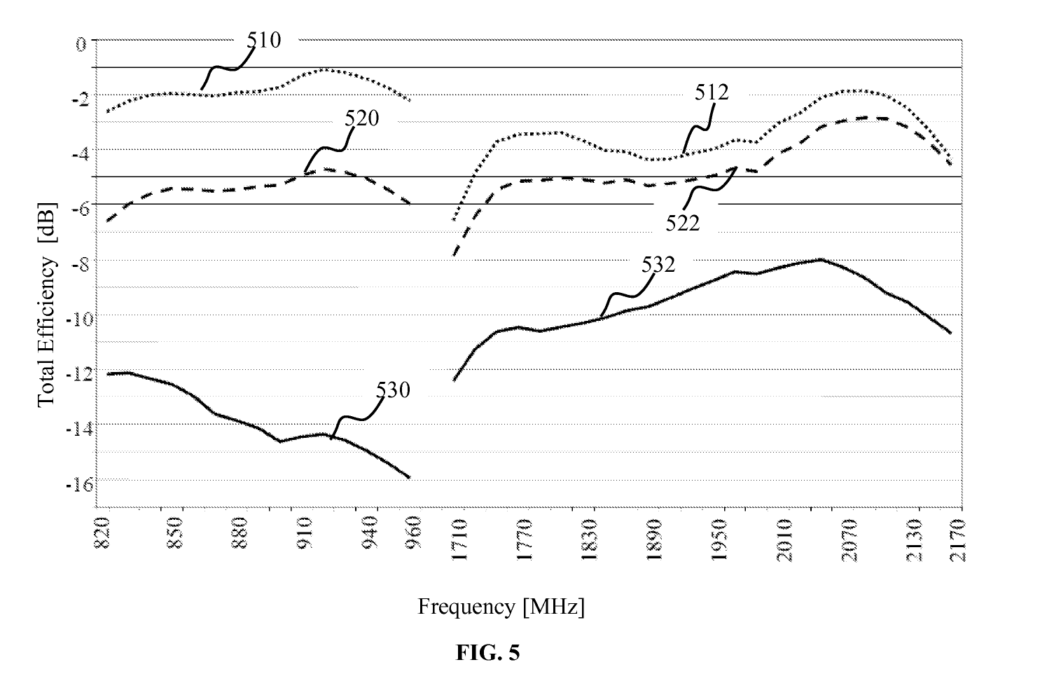

FIG. 5 presents data regarding measured efficiency for the same antenna as described above with respect to FIG. 4. Efficiency of an antenna (in dB) is defined as decimal logarithm of a ratio of radiated to input power:

$$AntennaEfficiency = 10 {log}_{10} ( \frac{Radiated Power}{Input Power} ) \qquad Eqn . ( 1 )$$

An efficiency of zero (0) dB corresponds to an ideal theoretical radiator, wherein all of the input power is radiated in the form of electromagnetic energy.

Measurement presented in FIG. 5 are taken as follows: (i) free space, depicted by the curves denoted 510, 512; (ii) measured according to CTIA 3.1 specification beside head, right cheek depicted by the curves denoted 520, 522; and (iii) measured according to CTIA 3.1 specification beside head, with hand by right cheek, depicted by the curves denoted 530, 532.

The total efficiency measurements presented in FIG. 5, show free space efficiency between −3 and −1 dB in the lower frequency band, and between −4 and −2 dB in the high frequency band. Efficiency measurements taken in the presence of dielectric loading (the curves 520, 522, 530, 532) show a reduction in efficiency, compared to the free space measurements (the curves denoted 510, 512). However, the efficiency reduction of the loosely-coupled conductive end cap antenna of the invention is substantially smaller, particularly in the frequency range from 820 MHz to 960 MHz, when compared to the capacitively coupled diversity antenna of the prior art. Comparison between the two antenna responses demonstrates a substantially higher efficiency (3 dB to 7 dB) of the main loosely coupled end cap antenna of the invention in free space and beside the head, as compared to the capacitively fed antenna of the prior art.

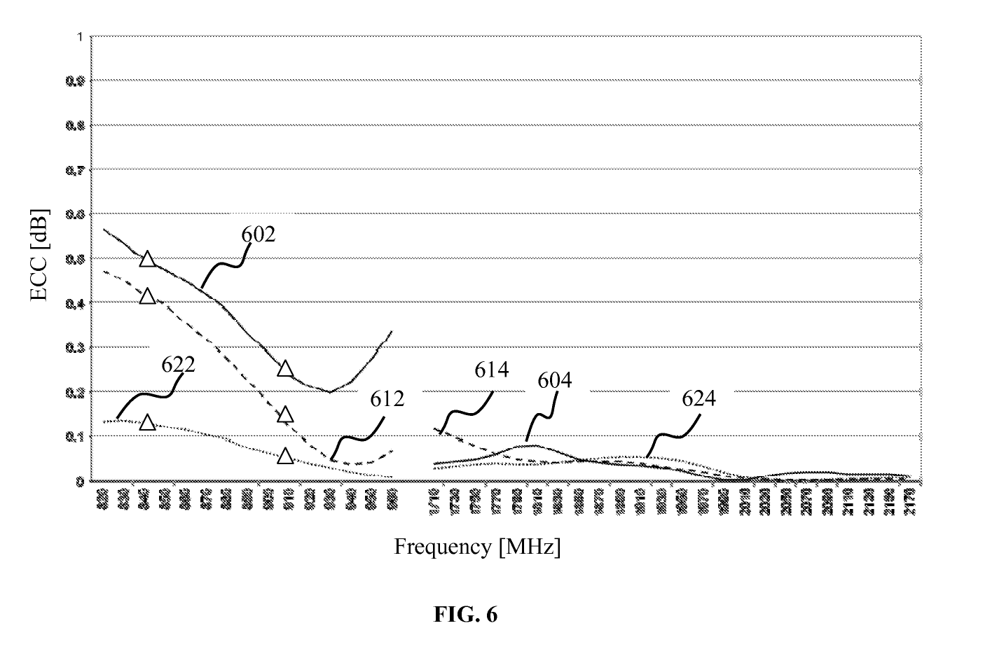

FIG. 6 presents data regarding measured envelope correlation coefficient (ECC) between the exemplary implementation of the main loosely-coupled antenna of the present invention and capacitively coupled monopole diversity antenna of prior art. The curves marked with designators 602, 604 correspond to the measurements taken in free space; the curves marked with designators 612, 614 correspond to the measurements taken according to CTIA 3.1 specification beside head, right cheek; and the curves marked with designators 622, 624 correspond to the measurements taken according to CTIA 3.1 specification beside head with hand by the right cheek (BHHR). Data shown in FIG. 6 advantageously exhibit low ECC between the main and the diversity antenna at high frequencies in all configurations, and in the lower frequency band when operating in BHHR CTIA 3.1 configuration, that closely reproduces typical operating conditions during device use.

The data presented in FIGS. 4-6 demonstrate that a multiband antenna comprising loosely coupled conductive end cap acting as a parasitic resonator is capable of operation within a wide frequency range; e.g., covering an exemplary lower frequency band from 824 to 960 MHz, as well as a higher frequency band from 1,710 MHz to 2,170 MHz, while maintaining low losses and high radiation efficiency as compared to a capacitively coupled antenna designs of the prior art.

Furthermore, a multiband antenna configured according to the invention advantageously does not require matching circuitry (thereby saving cost and space), and comprises a passive structure that does not use active switching, thus further reducing radiation losses, antenna size, and cost. A single connection to the device electronics is also utilized, which simplifies antenna installation and increases operational robustness. Increased bandwidth, particularly at lower frequencies, lower loses and improved isolation allow antenna multiband operation with a fully metallic device covers, while maintaining the same performance, device size, and/or antenna cost as with non-metallized or only partially metallized device covers.

This capability advantageously allows operation of a portable computing device with a single antenna over several mobile frequency bands such as GSM850, GSM900, GSM1900, GSM1800, PCS-1900, as well as LTE/LTE-A and/or WiMAX (IEEE Std. 802.16) frequency bands. Furthermore, the use of a separate tuning branch enables formation of a higher order antenna resonance, therefore enabling antenna operation in an additional high frequency band (e.g., 2500-2600 MHz band). Such capability further expands antenna uses to, inter alia, Wi-Fi (802.11) and additional LTE/LTE-A bands. As persons skilled in the art will appreciate, the frequency band composition given above may be modified as required by the particular application(s) desired, and additional bands may be supported/used as well.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

In one approach, a half-cup implementation may be used so that there is no metal on one side (for example, the top side of the device that, typically, comprises a display

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. Antenna apparatus, comprising:
a loosely coupled main antenna radiator having a single feed point connection;
a diversity antenna element;
wherein the antenna apparatus is configured to utilize at least a portion of a metallic enclosure of a host device as a parasitic resonator; and
wherein the antenna apparatus is capable of at least receiving signals in a plurality of frequency bands within both lower and upper operating frequency ranges.

2. The antenna apparatus of claim 1, wherein the antenna apparatus does not include any tuning circuitry or switches.

3. The antenna apparatus of claim 1, wherein the host device comprises a mobile cellular telephone, and the frequency bands are at least in part compliant with those specified in the Long Term Evolution (LTE) wireless standard.

4. The antenna apparatus of claim 1, wherein the antenna apparatus forms a first parasitic resonator using said main antenna radiator, and a second parasitic resonator using said diversity antenna element.

5. A radio frequency communications device, comprising:
an electronics assembly comprising a ground plane, and a feed port;
at least partially electrically conductive external enclosure comprising a main portion enclosing the electronics assembly, and a first end cap enclosing a first antenna radiator having a feed structure connected to the feed port;
wherein:
the first antenna radiator is configured to operate in at least a first frequency band; and
the first end cap is connected to the ground plane, at least at a first location, thereby forming a first parasitic radiator in a second frequency band.

6. The device of claim 5, wherein:
the first antenna radiator and the first parasitic radiator form a first multiband antenna apparatus; and
said first parasitic radiator is configured to widen an operating bandwidth of the first multiband antenna apparatus.

7. The communications device of claim 5, wherein said grounding of the first end cap is configured to increase radiation efficiency of the first parasitic radiator.

8. The communications device of claim 7, wherein said first end cap is disposed proximate a first end of the device.

9. The communications device of claim 8, wherein said external enclosure is fabricated from metal.

10. The communications device of claim 9, wherein said external enclosure comprises a non-conductive carrier and a conductive layer disposed thereon.

11. The communications device of claim 9, wherein:
said main portion is connected to the ground plane in at least one location; and
said connection of the first end cap to the ground plane is effected via the main portion.

12. The communications device of claim 9, wherein the first end cap is connected to the ground plane via a direct connection.

13. The communications device of claim 9, wherein said first end cap is separated from said main portion by a gap extending substantially around a circumference of the enclosure.

14. The communications device of claim 8, wherein:
said at least partially electrically conductive enclosure further comprises a second end cap disposed proximate a second end of the device, the second end opposite the first end, the second end cap enclosing a second antenna radiator having a feed structure connected to the feed port and configured to operate in at least said first frequency band.

15. The communications device of claim 14, wherein:
the second end cap is connected to the ground plane, at least at a second location, thereby forming a second parasitic radiator in said second frequency band;
the second antenna radiator and the second parasitic radiator form a second multiband antenna apparatus; and
said second parasitic radiator is configured to widen an operating bandwidth of the second multiband antenna apparatus.

16. The communications device of claim 15, wherein said second end cap is separated from said main portion by a second gap extending substantially around a circumference of the enclosure.

17. A multiband antenna apparatus for use in a radio communications device having at least partially conductive external enclosure, the antenna apparatus comprising a directly fed radiator structure, having a feed portion configured to be connected to feed port of the radio communications device;
wherein:
said directly fed radiator structure is operable in at least a first frequency band and configured to be electromagnetically coupled to an end cap portion of the external enclosure;
said end cap is electrically connected to a ground plane of the radio device via a ground structure;
said grounding of the end cap is configured to widen operating bandwidth of the multiband antenna apparatus; and
said enclosing of said directly fed radiator structure by said end cap and said grounding of the end cap cooperate to form a parasitically-fed radiator of the antenna apparatus in a second frequency band.

18. The antenna apparatus of claim 17, wherein said grounding of the end cap is configured to increase radiation efficiency of the multiband antenna apparatus.

19. The antenna apparatus of claim 17, wherein said second band is lower than said first band.

20. The antenna apparatus of claim 17, wherein said end cap is configured to substantially enclose the directly fed radiator structure on at least on five sides.

21. The antenna apparatus of claim 17, wherein said ground plane is spaced from said directly fed radiator structure by a predetermined ground clearance.

22. The antenna apparatus of claim 17, wherein said directly fed radiator structure comprises a first portion configured substantially parallel to said ground plane, and a second portion configured substantially perpendicular to said ground plane.

23. The antenna apparatus of claim 17, wherein the antenna comprises a parasitic radiator disposed proximate to said feed portion and configured to form an electromagnetically coupled resonance in at least a third frequency band.

24. The antenna apparatus of claim 23, wherein said second band is lower that said third band.

25. The antenna apparatus of claim 17, wherein said ground structure comprises at least a portion of a main portion of the external enclosure.

26. The antenna apparatus of claim 17, wherein said ground structure comprises a direct connection to the ground plane.

27. A method of expanding operational bandwidth of a multiband antenna useful in a radio device having at least partially conductive external enclosure, the method comprising:
energizing a first radiator structure in at least a first frequency band by effecting an electric connection between the first radiator and a feed port of the radio device; and
energizing a second antenna radiator structure in at least a second frequency band by:
(i) electromagnetically coupling the second radiator structure to the feed port; and
(ii) effecting an electric ground connection between the second radiator structure and a ground plane of the radio device.

28. The method of claim 27, wherein said electric ground connection is effectuated via a direct connection to the ground plane.

29. The method of claim 27, wherein:
said second radiator structure comprises an end cap portion of the external enclosure; and
the end cap portion is connected to the ground plane, at least at a first location that is selected to widen operating bandwidth of the multiband antenna.

30. The method of claim 29, wherein said end cap portion is configured to substantially enclose the antenna apparatus at least on five sides.

31. The method of claim 29, wherein said grounding of the end cap is configured to increase radiation efficiency of the multiband antenna.

32. An antenna radiator structure for use in a wireless device, the structure comprising:
a directly fed radiating element in electrical communication with a feed structure; and
a second radiating element with a slot formed therein;
wherein the directly fed radiating element and said second radiating element are configured to be disposed in a substantially perpendicular orientation when installed within a host device enclosure.

33. The structure of claim 32, further comprising a parasitic element adapted for communication with a ground of the host device, the parasitic element configured for placement proximate the feed structure and to resonate at a frequency other than that of said directly fed radiating element or said second radiating element.

34. The structure of claim 32, wherein the slot is configured to create a first resonant frequency of a high frequency band associated with the structure.

35. The structure of claim 34, wherein the directly fed radiating element comprises an end portion used to tune a first harmonic of a low band resonance into the high frequency band, thus forming a second high frequency resonance.
